(19) United States
(12) Patent Application Publication
(10) Pub. No.: US 2006/0196041 A1
(43) Pub. Date: Sep. 7, 2006

(54) Method of making a coil for an electrical motor

(75) Inventor: Ole Hansen, Humlebaek (DK)

Correspondence Address: MCCORMICK, PAULDING & HUBER LLP, CITY PLACE II, 185 ASYLUM STREET, HARTFORD, CT, 06103, US

(73) Assignee: Danfoss A/S, Nordborg (DK)

(21) Appl. No.: 10/567,633

(22) PCT Filed: Aug. 5, 2004
(86) PCT No.: PCT/DK04/00525

§ 371 Date: Feb. 8, 2006

(30) Foreign Application Priority Data
Aug. 9, 2003 (DK) PA2003 01150

(51) Int. Cl. H01F 7/06

(52) U.S. Cl. 29/606; 29/605

(57) ABSTRACT

The invention provides a method for simplifying manufacturing of electrical motors by making a sheet with a plurality of windings of a conductive wire. The sheet is rolled into a tubular body which is inserted into a tubular stator element made from a magnetically conductive material, and pressed into contact with an inner surface thereof. According to the invention, a part of an outer surface of a mandrel is covered with a non-adhesive layer and with an adhesive layer. Subsequently, a wire is coiled onto the mandrel in contact with the adhesive layer. Due to the non-adhesive layer, the coil may easily be removed from the mandrel, and due to the adhesive layer, the windings of the coil are kept in place during a subsequent flattening of the coil. Accordingly, disorder between the windings of the coil can be avoided and a motor with an improved capacity can be manufactured more easily.

### CROSS REFERENCE TO RELATED APPLICATIONS

This application is entitled to the benefit of and incorporates by reference essential subject matter disclosed in International Patent Application No. PCT/DK2004/000525 filed on Aug. 5, 2004 and Danish Patent Application No. PA 2003 01150 filed Aug. 9, 2003.

### FIELD OF THE INVENTION

The present invention relates to a stator coil and a method of making a coil for an electrical motor of the kind comprising a stator with a tubular core and a tubular coil arranged in contact with the inner surface thereof. In particular, the invention relates to a sheet structure comprising two layers of windings which can be joined with a core of a stator or rotor to induce a magnetic field therein. The invention further relates to a sheet structure and a tubular core joined therewith.

### BACKGROUND OF THE INVENTION

In general, electrical motors with a stator of the above mentioned kind exist. In traditional motors, the windings of the coil are arranged in axially extending groves of the core. In order to conduct magnetism, the core is made from a material comprising iron. The principle of winding the coil in groves of the core supports generation of a strong electrical field and keeps the windings in place. The making of such a winding is, however, time consuming and requires skills and very specific and expensive production equipment. Furthermore, this motor type has the disadvantage of cogging because of the slots. As an alternative, motors exist wherein a pre-wound coil is formed into a hard tubular coil element comprising a plurality of windings of a conductive wire. The tubular coil element is glued to the inner surface of a tubular core element. This second motor type is easier to manufacture but, in contrary to the firstly mentioned motor type, the insertion of a tubular coil element into the tubular core element increases the distance between the core and the rotor of the motor and thus reduces the performance of the motor.

The tubular coil element of the secondly mentioned motor type is typically made by winding an insulated conductive wire onto a mandrel. After the winding, the wire is removed from the mandrel in the form of a helical wire coil. Subsequently, the helical coil is tilted and flattened to form a sheet of windings and the sheet is subsequently rolled to form a tubular coil element which can be inserted into and fastened to a tubular core element. When the helical coil is removed from the mandrel, it becomes limp and in order not to deform the coil, it must be handled with care. During the tilting and flattening procedure, it is difficult to avoid disorder in the helical coils and the cross-sectional shape is most often deformed whereby wires get tangled and typically some windings overlap other windings whereby the thickness of the coil increases. Due to the increased thickness, there is a need for a larger air gap between the core and the coil, and therefore the efficiency of the motor is reduced. The tubular coil element is normally hardened, e.g. by backing of a wire-paint, or so called lacquer, in an oven. The hard tubular coil element is subsequently inserted into the tubular core. The hardened tubular element can not be expanded into contact with an inner surface of the core, and in order to establish a solid contact between the coil element and the core, the gap therein between is filled with hardening glue. The resulting distance between the tubular core element and the rotor, i.e. the thickness of the glue layer and the thickness of the coil element, is relatively large resulting in a reduced performance of the motor.

### BRIEF SUMMARY OF THE INVENTION

In accordance with the present invention, provision is made for a method of making windings for an electrical motor, said method supporting easy manufacturing and good performance of an electrical motor. Accordingly, the present invention in a first aspect provides a method for making a sheet with a plurality of windings of a conductive wire, e.g. for use in an electrical motor, said method comprising the steps of:
covering a part of an outer surface of a mandrel with a non-adhesive layer,
covering a part of the outer surface of the non-adhesive layer with an adhesive layer,
coiling the wire onto the outer surface of the mandrel to form a wire coil in contact with the adhesive layer,
removing the wire coil and at least a part of the adhesive layer from the mandrel, and
flattening the wire coil to form a sheet structure comprising two layers of windings being joined by the adhesive layer.

Due to the coiling of the wire onto the adhesive layer, each layer of the wire coils is joined with adjacent layers at the time when the coil is removed from the mandrel and the tilting and flattening of the coils to form the sheet structure of layers of windings is easier and leads to less deformation of the cross-sectional shape of the windings and thus supports better performance when used in an electrical motor. In an electrical motor, the sheet structure may be fastened to a core of a magnetically conductive material, e.g. a tubular core element forming either the rotor or the stator of an electrical motor. According to one embodiment of the present invention, a sheet structure of a thickness substantially corresponding to two times the thickness of the wire plus two times the thickness of the adhesive layer applied to the outer surface of the non-adhesive layer may be achieved. Compared to the wall thickness of the tubular coil element of existing motors, the direct correlation between the thickness of the wire and adhesive layer and the total thickness represents a significant difference. In the existing motors, it is not unusual that deformation of windings during removal of the wire coil from a mandrel and the subsequent flattening of the wire coil results in a total wall thickness which is a factor 3 times the sum of the thicknesses of the wires of the winding layers of the wire coil.

The non-adhesive layer could be a non-stick coating applied to the mandrel prior to application of the adhesive layer. The non-adhesive layer could be a PTFE layer applied to the outer surface of the mandrel or it could be any non-stick coating, e.g. of the kind known for moulding plastic components in a mould. Both the non-adhesive layer and the adhesive layer may be applied to the mandrel by spraying or by any similar painting technique. Preferably, the non-adhesive layer is a flexible sheet material which could be a stripe of a plastic or paper backing of the kind used in connection with stickers, i.e. of the kind provided with a smooth or slippery surface structure supporting easy removal of the sheet of a sticky adhesive layer. The outer surface of the mandrel may be provided with fixation means for holding the flexible sheet material fixed to the mandrel, e.g. via suction or by means of a longitudinally extending slot, e.g. as a part of a tension bush arranged on the outer surface of mandrel to support removal of the wire coil from the mandrel.

Since the performance of an electrical motor depends on the distance between the rotor and the magnetic field inducted into the core, the performance of the motor can be increased by reducing the thickness of the layer of windings, i.e. the thickness of the sheet structure and thereby the wall thickness of a tubular coil element made by rolling up the sheet structure. Moreover, the performance can be increased by establishing a close contact between the sheet structure and the surface of the core element to which magnetism is to be induced, i.e. a core of the rotor or stator. The adhesive layer could be made of a resilient glue material, e.g. an acrylic or rubber based material. Due to the resiliency of the glue material, the sheet structure becomes more flexible and thus easier to deform and to press into contact with a surface of the core element which is an advantage, not least when the core element is tubular and thus has curved outer surfaces. Moreover, use of a resilient glue material may extensively reduce noise from an electrical motor to which the sheet structure is applied.

At least a part of, or the entire non-adhesive layer may be removed from the mandrel together with the wire coil and adhesive layer. In that way, the adhesive layer may be protected from dust etc. until a later stage in the production when the wire coil is to be flattened. Prior to the flattening, the non-adhesive layer may be removed to expose the adhesive layer and thus to allow joining of the two layers in the sheet structure.

The wire could be a regular insulated electrically conductive wire of the kind known for winding wire coils for electrical motors, e.g. a 0.15 mm. wire with one or two layers of a lacquer, e.g. an inner layer with a melting point which is higher than the melting point of an outer layer. This allows further joining between each winding in the wire coil by heat treating the coil at a temperature between the melting points of the two lacquers.

In order to further support the structure and to prevent deformation of the wire coil during removal of the coil from the mandrel or during flattening of the coil, at least one elongate stripe of a rigid sheet material may be applied to an outer surface of the adhesive layer. The stripe may preferably be applied in an axial direction of the wire coil e.g. to extend from one axial end portion to an opposite axially disposed end portion thereof. In a particularly preferred embodiment, two stripes are applied axially to the outer surface on each side of the wire coil, i.e. with approximately 180° between each stripe. In order to prevent deformation of the wire coil, the stripe is preferably more rigid than the non-adhesive layer, and preferably, the stripe offers resistance to bending in at least one direction in which direction it therefore becomes difficult to deform the stripe using finger pressure whereas the stripe may be easier to deform in other directions. Such a characteristic may be found e.g. in wire nettings and e.g. in a relatively stiff plate made with a plurality of parallel recesses weakening the plate against bending in one direction. Accordingly, the stripe may be applied axially to the outer surface of the resilient glue material and by moderate finger pressure be bended to follow the curvature of the outer surface of the mandrel. The stripe could be made from a meshed material, e.g. a cloth of a wire netting. In particular, the stripe may be made from a wire netting with mesh size allowing the glue to easily be pressed there through. The wire of the netting could be chosen with a diameter which is smaller than the diameter of the wire of the wire coil so that the thickness of the stripe contributes only very little to the total thickness of the wire coil including the wires, the adhesive layer and the stripe. The stripe could be made from steel wires with a diameter in the size of 0.05-1.0 mm. and a mesh opening size in the range of 0.1-5.0 mm² or the stripe could be made from a composite material comprising glass or carbon fibres and a resin of polyester or epoxy. The stripe material should preferably have a rigid surface shape preventing deformation in the surface plane, i.e. preventing changes to the angles between the edges of the stripe.

In order to facilitate removal of the wire coil from the mandrel, a radial dimension of the mandrel may be reduced prior to the removing of the wire coil and at least a part of the adhesive layer form the mandrel. As an example, the mandrel may have an outer surface formed by a sleeve or a tension bush with a longitudinally extending slit allowing the sleeve or bush to be pressed into a smaller radial dimension or the mandrel could be formed as a resilient hose, e.g. of a rubber material which, when filled with a fluid medium at a certain pressure, becomes sufficiently stiff to exert backpressure for the coiling process. Prior to the removing of the wire coil from the mandrel, the pressure is released causing the mandrel to collapse whereby the wire coil and at least a part of the adhesive layer are easily removed.

Prior to the flattening, the wire coil may be deformed into an arbitrary cross-sectional shape by expansion using elongate expanding elements inserted into the wire coil. After insertion of the elements into the coil, the elements are moved away from each other. During the expansion of the wire coil, a peripheral outer shape of the expanding elements could be embossed into the wire coil. Preferably, the elements could be steel bars with a circular cross-sectional shape but they may in fact have any cross-sectional shape and they could be made from any rigid material. Since coiling of a wire onto a mandrel having a polygonal shape may cause problems when the wire is bending around sharp edges, the wire is preferably coiled onto a mandrel having a circular cross-sectional shape and subsequently, the coil could be expanded into a cross-sectional shape with a curved outer contour, e.g. an oval cross-sectional shape. Alternatively, the wire coil is expanded into a cross-sectional shape which is polygonal, e.g. a rhombus shape or a quadrangular shape, or a pentagonal shape or a hexagonal shape.

Due to resiliency of the glue, the sheet structure becomes flexible. Due to the flexibility, the sheet structure may be rolled up to form a flexible tubular coil element which can be inserted into a tubular core element, e.g. forming a stator or a rotor for an electrical motor. Preferably, the sheet structure is made in a dimension so that the length of the tubular coil element exceeds the length of the corresponding tubular core element. This allows the coil element to be arranged, e.g. coaxially inside or outside the core element to co-extend the coil element in both of its axially disposed ends. Typically, the thickness of the sheet structure is slightly increased at the area where the wire was folded during the flattening of the wire coil. Preferably, the sheet structure is rolled into a tubular coil element wherein the folds of the wire, caused by the preceding flattening of the wire coil, is located only along the axially disposed end portions of the tubular coil element, and preferably this part of the tubular coil element is located outside the tubular core element.

After insertion of the tubular coil element into the tubular core element, the coil element may be expanded radially outwardly and thus be brought into close contact with an inner surface of the core whereby the distance between the rotor and the stator of the motor can be reduced.

During tilting and flattening of the wire coil, adhesive layers on end portions of each of the two layers of windings in the sheet structure are exposed. In order to maintain the tubular shape of the sheet structure, these two opposite end portions may be adhesively joined, e.g. by use of the exposed adhesive layers or by use of additional glue applied to the end portions.

As an alternative to the outward expansion into contact with the tubular core element, the sheet structure can be rolled up to, or expanded up to a larger radial size then the inner radial size of the tubular core element. During insertion, the tubular coil element is squeezed into the tubular core element and due to its flexibility, it presses outwardly against the inner surface of the tubular core element.

In order to improve contact between an inner surface of the core and the tubular coil element, glue may be applied to at least one of a portion of the outer surface of the tubular coil element and the inner surface of the core element prior to the insertion of the tubular coil element into a tubular core. The glue could be of any kind capable of joining the two components together, e.g. a resilient glue material. The glue could be applied to the surface by spraying or using a brush or using glue application tape.

As an alternative to the rolling up of one single sheet structure to form a tubular coil element, more than one sheet structures, each comprising two layers of windings, may be arranged in close contact with an inner surface of the tubular core element. As an example, three individual sheet structures for connection to three phases of an alternating current could be arranged to follow an equally large circumferential part of the tubular core, e.g. 120° thereof. The more than one sheet structure could be flattened individually and they could be joined individually to the core element or they may be joined together to form one new sheet structure comprising layers of windings of several separate wires for subsequent joining with the core element.

In order to speed op the manufacturing process, the flexible sheet material and the adhesive layer of a resilient glue material could be applied to the mandrel in one operation, e.g. in the form of a glue application tape with the adhesive layer pre-applied to a flexible sheet material. As an example, a Scotch Very High Bond tape from 3M may be used, e.g. comprising a rubber or acrylic glue with a plastic cover paper.

In a second aspect, the present invention relates to a wire coil for an electrical motor and made in accordance with any of the above described steps of the method according to the first aspect of the invention.

### BRIEF DESCRIPTION OF THE DRAWINGS

In the following, a preferred embodiment of the invention will be described in further details with reference to the drawing in which:

FIG. 1, shows a mandrel with a glue application tape on the outer surface thereof,

FIG. 2 shows the mandrel of FIG. 1, with two stripes of a material applied to the outer surface of the glue application tape,

FIG. 3 shows the mandrel of FIGS. 1 and 2, with a plurality of wire coil wound onto the outer surface thereof,

FIG. 4 shows a wire coil when removed from the mandrel,

FIG. 5 shows the wire coil of FIG. 4 deformed into an oval cross-sectional shape,

FIGS. 6-7 show flattening of a wire coil to form a sheet structure,

FIG. 8 shows rolling of the sheet structure to form a tubular coil element,

FIGS. 9-12 show cross-sectional views of a tubular coil element before and after insertion into a core element and before and after expansion into contact with an inner surface of the core element.

FIG. 13 shows a view of a sheet structure from both sides,

FIGS. 14 and 15 show flattening and rolling of a three phase single sheet structure directly onto a mandrel,

FIG. 16 shows three separate wire coils for a three phase motor flattened prior to the rolling of the sheet structure onto a mandrel,

FIG. 17 shows three separate wire coils for a three phase motor flattened and rolled directly onto a mandrel, and

FIGS. 18 and 19 show an alternative shape of the coil and a corresponding sheet structure.

### DETAILED DESCRIPTION OF THE INVENTION

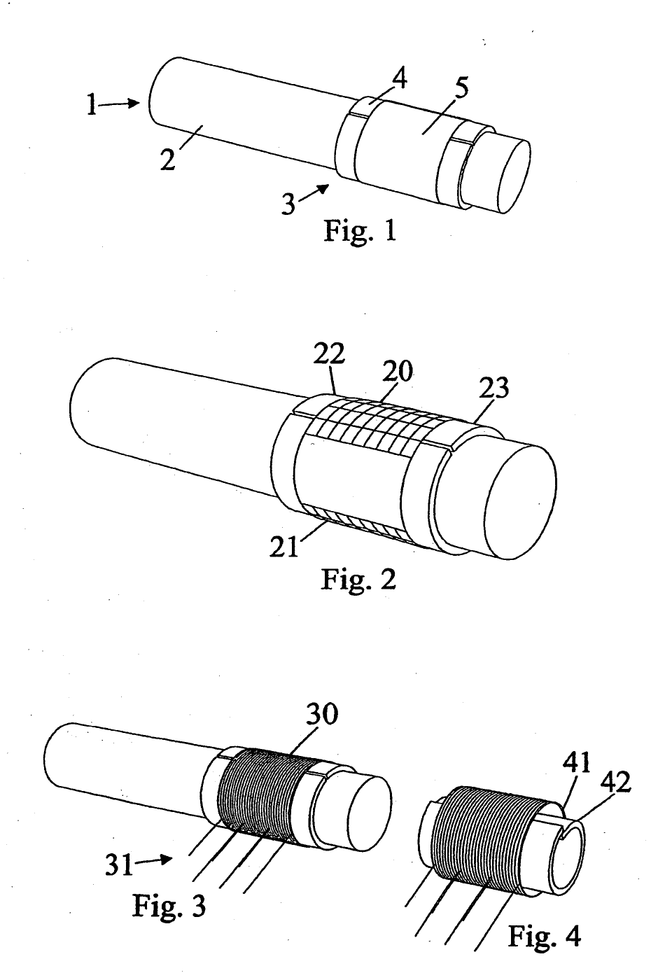

FIG. 1 shows a mandrel 1. A tension bush 3 is arranged on an outer surface of the mandrel to allow changes to the radial dimension of the mandrel for easy removal of the wire coil there from. On the outer surface 4 of the tension bush, a non-adhesive and an adhesive layer is applied in the form of a glue application tape 5 comprising a backing paper and a resilient glue material, e.g. a rubber or an acrylic material. The mandrel and the sleeve are made from a rigid material, e.g. steel, and it may in one end be connected to a driveshaft connected to power driven means for rotating the mandrel around its centre axis. The mandrel can be made with a slot for receiving a rim portion of the flexible sheet material to ease fastening of the material to the mandrel during wrapping of the sheet around the mandrel. For the same purpose, the mandrel could also be made with a plurality of small suction holes connected to a vacuum pump for maintaining the flexible sheet in place during application of the layer of a resilient glue material. The suction can be switched off prior to the subsequent removal of the wire coil from the mandrel.

FIG. 2 shows application of two stripes 20, 21 of a sheet material which is more rigid than the flexile sheet material, e.g. a piece of a wire netting, a piece of a composite material, e.g. carbon or glass fibre reinforced polyester or epoxy or a piece of cloth applied to the outer surface of the layer of a resilient glue material. The stripes are longitudinal stripes applied in an axial direction from one axial end portion 22 to an opposite axially disposed end portion 23.

FIG. 3 shows the mandrel of FIGS. 1 and 2 after application of a number of windings 30 of the wire 31, e.g. a 0.15 mm. wire with an insulation layer, e.g. made from a lacquer. The disclosed wire is a 0.15 mm wire made from copper. The wire is coiled onto the outer surface of the layer of a resilient glue material so that each winding is joined to adjacent windings, and optionally, the coil is winded in more layers. Furthermore, the wire coil can be made from more than one piece of a wire. E.g. for a 2-phases or a 3 phases electrical motor wherein 2 or 3 separate and electrically isolated pieces of wire is coiled onto one and the same mandrel to form one uniform wire coil comprising 2 or 3 electrically isolated wires to be connected to individual phases of an alternating current. After application of a sufficient number of windings, e.g. in one or more layers, the helical wire coil is removed from the mandrel.

In FIG. 4, the wire coil is removed from the mandrel. In this state, the shape of the wire coil is maintained only by the stiffness of the wire in combination with the layer 41 of a resilient glue material and the two rigid stripes (not visible in FIG. 4) and one of either the flexible sheet material or tension bush 42.

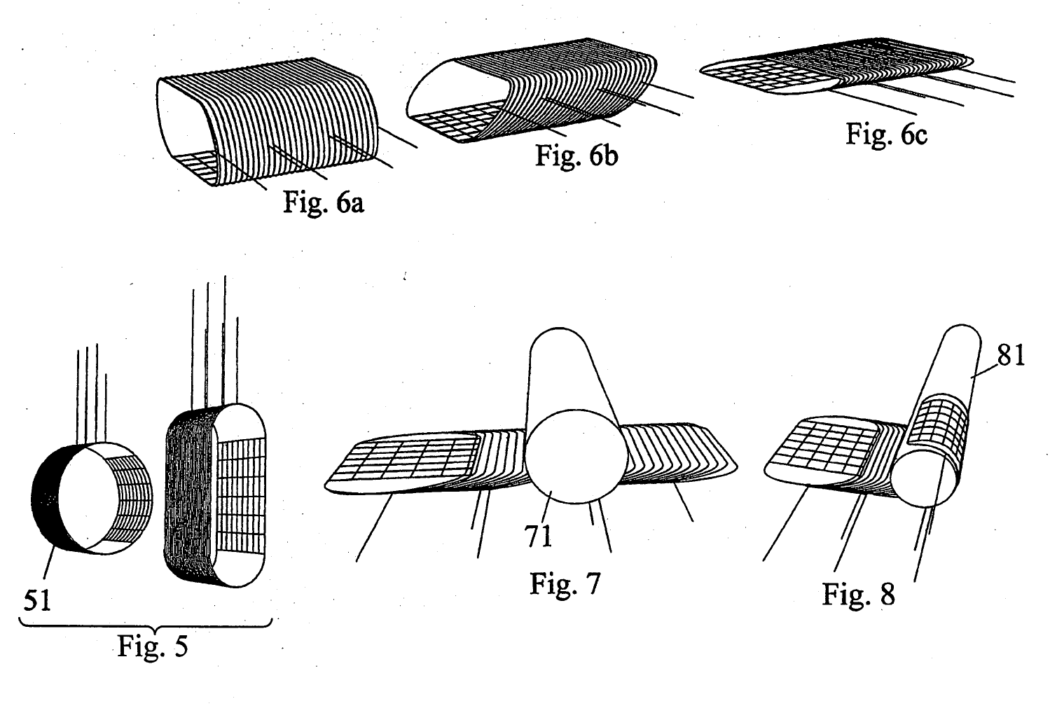

In FIG. 5, the flexible sheet material is removed while the two stripes 51 of a rigid material are left inside the coil to support reshaping by deformation of the coil. The wire coil is easily shaped into a preferred cross-sectional shape, e.g. by insertion of elongate shape defining elements axially into the wire coil. In FIG. 4, the cross-sectional shape is an oval shape, but the shape could also be a quadrangular or polygonal shape. As shown, the flexible sheet material has been removed to expose the layer of a resilient glue material on the inner surface of the wire coil. The glue serves to glue together the wire coil resiliently, when the coil is tilted and flattened to form a sheet structure comprising two layers of windings.

FIGS. 6a-6c show tilting and flattening of the wire coil to form a sheet structure comprising two layers of windings.

FIG. 7 shows a cylindrical roller 71, which is being used for flattening a coil to form a sheet structure.

In FIG. 8, the sheet structure of FIG. 7 is rolled onto the cylindrical mandrel 81 to form a tubular coil element. The mandrel 81 could be identical to the roller 71 in FIG. 7.

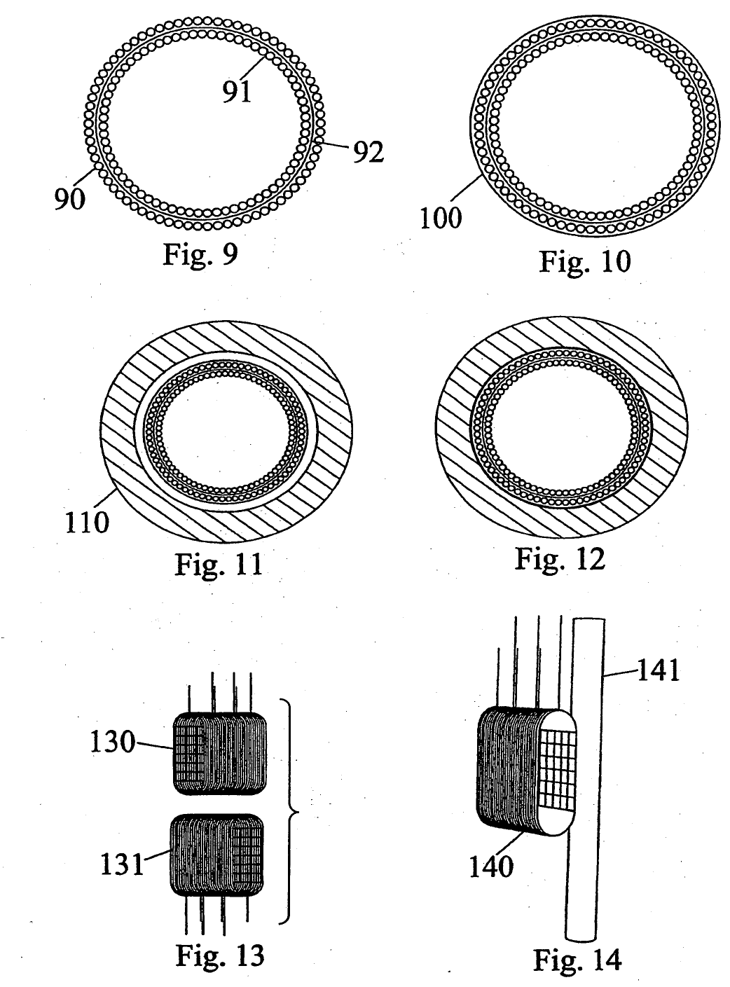

FIG. 9 shows a cross-sectional view of a tubular coil element rolled from a sheet structure comprising two layers of windings 90, 91 joined by an adhesive layer 92. The adhesive layer 92 is the same layer which is shown in FIG. 1, c.f. referral number 5.

FIG. 10 shows a cross-sectional view of the tubular coil element also shown in FIG. 9 after application of an adhesive layer 10 for adhesively joining the tubular coil element to an inner surface of a tubular core element of an electrical motor.

FIG. 11 shows a cross-sectional view of the tubular coil element of FIG. 10 inserted into a tubular core element 110. As indicated, the tubular coil is not yet expanded.

In FIG. 12, the tubular coil element has been expanded into contact with the inner surface of the tubular core element to form a stator part of an electrical motor, ready for receiving a cylindrical rotor.

FIG. 13 shows a view of a front side 130 and a rear side 131 of a sheet structure comprising two layers of windings of a conductive wire.

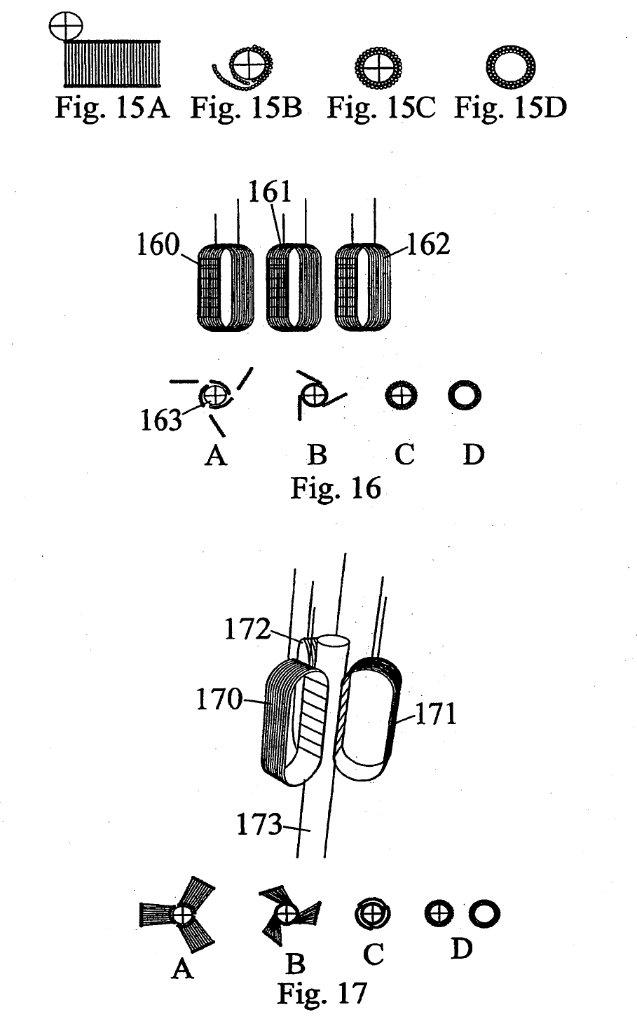

FIG. 14 shows a 3D view of a mandrel 141 to which one side of a wire coil 140 is attached. In FIG. 15, it is shown in cross-sectional views A-D how the tilting and flattening of the wire coil to form a sheet structure simultaneous with the rolling up of the sheet structure to form a tubular coil element by rolling the wire coil around the mandrel. In view A, one edge of the wire coil is joined to the mandrel, in view B the wire coil is rolled around the mandrel, in view C a tubular coil element has been formed and in view D an adhesive layer has been applied to the outer surface of the tubular coil element to prepare insertion of the coil element into a tubular core element for expansion into the inner surface thereof.

FIG. 16 shows a view of three sheet structures 160, 161, 162 for a three phase electrical motor. In the four views A-D it is shown how the three sheet structures may be formed into a tubular coil element in one operation. In view A, an edge of each of the sheets is fastened to the outer surface of the mandrel 163. In view B the sheet structures are rolled around the mandrel and in view C, a tubular coil element comprising three individual phase wires is formed. In view D, an adhesive layer is applied to the outer surface to prepare insertion and fastening of the tubular coil element into a tubular core element.

In FIG. 17, three wire coils 170, 171, 172 are fastened to a mandrel 173. By rolling the wire coils around the mandrel, the coils are tilted, flattened and formed into a tubular coil element in one operation. The operation is shown in the cross-sectional views A-D.

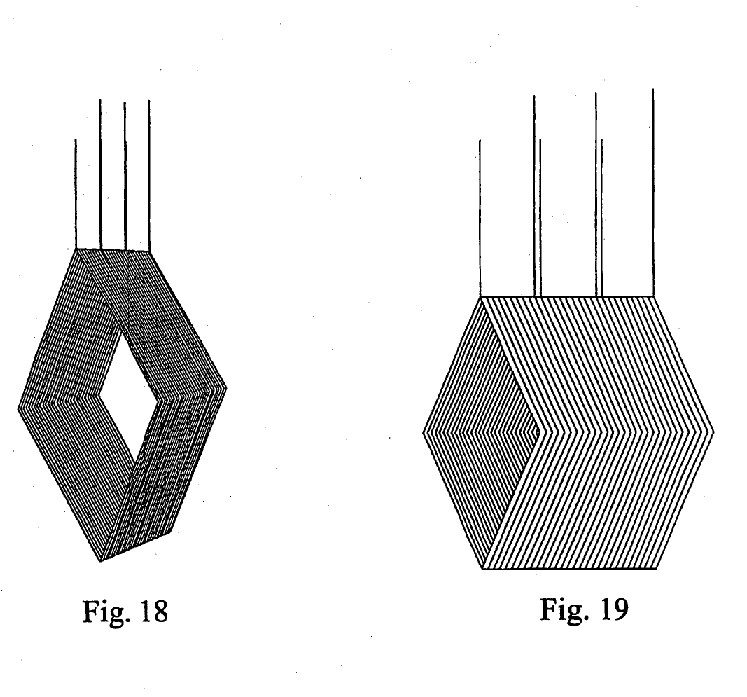

FIG. 18 shows a view of a rhombus shaped wire coil, i.e. a coil which is achieved by winding the wire around a mandrel with a rhombus formed cross-sectional shape. In FIG. 19, the coil is flattened to form a sheet structure. Except from the rhombus shape, the coil and the sheet structure corresponds to the previously described coils. By tests, it has been found that the rhombus shape reduces disorder in the wire coils when the coil is tilted and subsequently flattened to form the sheet structure, and the rhombus shape thereby facilitates an improved performance of the motor.

While the present invention has been illustrated and described with respect to a particular embodiment thereof, it should be appreciated by those of ordinary skill in the art that various modifications to this invention may be made without departing from the spirit and scope of the present invention.

1. A method for making a sheet with a plurality of windings of a conductive wire, said method comprising the steps of:
covering a part of an outer surface of a mandrel with a non-adhesive layer,
covering a part of an outer surface of the non-adhesive layer with an adhesive layer,
coiling the wire onto an outer surface of the adhesive layer to form a wire coil in contact with the adhesive layer,
removing the wire coil and at least a part of the adhesive layer from the mandrel, and
flattening the wire coil to form a sheet structure comprising two layers of windings being joined by the adhesive layer.

2. The method according to claim 1, wherein the non-adhesive layer is a flexible sheet material.

3. The method according to claim 1, wherein the adhesive layer is made of a resilient glue material.

4. The method according to claim 1, wherein at least a part of the non-adhesive layer is removed from the mandrel together with the wire coil and adhesive layer, and wherein the non-adhesive layer is removed to expose the adhesive layer prior to the flattening of the wire coil.

5. The method according to claim 1 further comprising the step of applying at least one elongate stripe of a sheet material to an outer surface of the adhesive layer.

6. The method according to claim 5, wherein the stripe is applied in an axial direction of the wire coil to extend from one axial end portion to an opposite axially disposed end portion thereof.

7. The method according to claim 5, wherein the stripe is more rigid than the non-adhesive layer.

8. The method according to claim 7, wherein the stripe is made from a material selected from the group consisting of glass fibres, carbon fibres, epoxy, polyester, steel, wires of steel and any composition thereof.

9. The method according to claim 1, wherein a redial dimension of the mandrel is reduced prior to the removing of the wire coil and at least a part of the adhesive layer form the mandrel.

10. The method according to claim 1 further comprising the step of expanding the wire coil prior to the flattening by inserting elongate expanding elements into the wire coil and by moving the expanding elements away from each other.

11. The method according to claim 1 further comprising the step of rolling the sheet into a tubular coil element.

12. The method according to claim 11, wherein the rolling of the sheet into a tubular coil element is performed by fastening an end portion of the sheet structure to a mandrel and by subsequent rolling of the sheet structure around the mandrel.

13. The method according to claim 11 further comprising the step of applying an adhesive layer to at least one of
a surface of the tubular coil element, and
a surface of a corresponding core,
prior to joining the coil element and the core element to form a stator or a rotor for an electrical motor.

14. The method according to claim 13, wherein the tubular coil element is expanded into dose contact with an inner surface of the tubular core element.

15. The method according to claim 11 wherein edge portions of at least two sheet structures are joined to form one unified sheet structure prior to the rolling of the unified sheet structure into a tubular coil element.

16. The method according to claim 1, wherein the flattening of the wire coil to form a sheet structure comprising two layers of windings comprises the steps of:
fastening a peripheral outer surface of the wire coil to a mandrel, and
rolling the wire coil around the mandrel to tilt and flatten the wire coil.

17. The method according to claim 1 wherein the non-adhesive layer and the adhesive layer is applied to the mandrel in one operation in the form of a glue transferring tape with the adhesive layer pre-applied to a non-adhesive layer.

18. The method according to claim 1, wherein the adhesive layer comprises a resilient glue material which is based on a material selected from the group consisting of rubber or wherein the glue material is based on acrylate or acrylic acid.

19. A flexible wire coil for an electrical motor and comprising a plurality of windings made form an insulated electrically conductive wire, each winding being adhesively joined to adjacent windings by a resilient glue material.

20. The coil according to claim 19, wherein the wire coil is flattened to form a sheet structure comprising two layers of windings.

21. The coil according to claim 20, wherein the sheet structure is rolled and wherein opposite peripheral end parts of the sheet are joined to form a flexible tubular coil element.

22. The coil according to claim 21, inserted into and expanded into contact with an inner surface of a tubular core element made from a magnetically conductive material.
